(19) United States
(12) Patent Application Publication
(10) Pub. No.: US 2006/0146895 A1
(43) Pub. Date: Jul. 6, 2006

(54) Apparatus for controlling laser output

(75) Inventor: Jong-min Lee, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/296,360

(22) Filed: Dec. 8, 2005

(30) Foreign Application Priority Data
Jan. 6, 2005 (KR) 2005-0001149

(51) Int. Cl. H01S 3/13

(52) U.S. Cl. 372/29.021

(57) ABSTRACT

Provided is an apparatus for controlling a laser output comprising a common-anode laser diode having a first light emitting and receiving units and a common-cathode laser diode having a second light emitting and receiving units. Further, the apparatus comprises an automatic power controller (APC) that operates in either one of two modes. In the first mode the APC controls the amount of light emitted from the first light emitting unit by comparing a first feedback voltage corresponding to an amount of light received by the first light receiving unit and a reference voltage. In the second mode, the APC controls the amount of light emitted from the second light emitting unit by comparing a second feedback voltage corresponding to an amount of light received by the second light receiving unit and a reference voltage. Still further, the apparatus comprises a switching unit which connects the APC and the common-anode laser diode and the apparatus comprises a bias direction forming unit which forms a bias direction between the switching unit and the common-cathode laser diode.

### BACKGROUND OF THE INVENTION

This application claims the benefit under 35 U.S.C. §119(a) of Korean Patent Application No. 2005-0001149, filed on Jan. 6, 2005 in the Korean Intellectual Property Office, the entire disclosure of which is hereby incorporated by reference.

1. Field of the Invention

The present invention relates to an apparatus for controlling the output of semiconductor lasers in a laser printer. More particularly, the present invention relates to an automatic power controller (APC) that can be used with both a common-anode laser diode and a common-cathode laser diode.

2. Description of the Related Art

A laser emitting device of a laser printer forms an electrostatic image on a photosensitive drum by toggling a semiconductor laser on/off. The electrostatic image is then transferred onto a print medium, such as a paper. The laser emitting device includes an APC to rapidly toggle the semiconductor laser on/off. The APC is either a discrete circuit made up of transistors or a combination of components, such as a driver integrated circuit (IC), resistors and capacitors.

FIG. 1 is an exemplary view of a conventional apparatus for controlling laser output of a common-anode type laser. As shown in FIG. 1, the apparatus for controlling laser output of a common anode type laser includes a common-anode laser diode 10 and an APC 30.

The common-anode laser diode 10 includes a light emitting diode (LED) 12 and a light receiving diode 14. In operation, the APC 10 compares a reference voltage to a feedback voltage that corresponds to the amount of light received by the light receiving diode 14. The APC 10 maintains the output of the LED 12 at a predetermined level according to the result of the comparison.

The LED 12 of the common-anode laser diode 10 forms a forward direction bias (1), and the light receiving diode 14 forms a reverse direction bias (2). An anode of the LED 12, which is a common node of the common-anode laser diode 10, is connected to a voltage source Vcc.

FIG. 2 is another exemplary conventional apparatus for controlling laser output of a common cathode type laser. As shown in FIG. 2, the apparatus for controlling laser output of the common cathode type laser includes a common-cathode laser diode 50 and an APC 70.

The common-cathode laser diode 50 includes an LED 52 and a light receiving diode 54. In operation, the APC 70 compares a reference voltage and a feedback voltage corresponding to the amount of light received by the light receiving diode 54. The APC 70 maintains the output of the LED 52 at a predetermined level according to the results of the comparison.

The LED 52 of the common-cathode laser diode 50 forms a forward direction bias (3), and the light receiving diode 54 forms a reverse direction bias (4). A cathode of the LED 52, which is a common node of the common-cathode laser diode 50, is connected to ground GND.

However, APC 30 illustrated in FIG. 1 and APC 70 illustrated in FIG. 2 need to be designed differently due to the differing bias directions associated with a common-anode type laser and common-cathode type laser. As can be seen in FIG. 1 and FIG. 2, the bias directions of the respective LEDs 12 and 52 and light receiving diodes 14 and 54 are opposite. Therefore, conventional APCs have to be designed differently depending on the type of laser diodes' to be used with the APCs.

Accordingly, there is a need for an improved apparatus for controlling a laser output of semiconductor lasers that can use both, a common-anode laser diode and a common-cathode laser diode, to simplify the internal circuit structure of semiconductor lasers. In addition, there is a need for an improved apparatus for controlling a laser output in a laser printer that enables a dual beam laser configuration while allowing a common-cathode laser diode to operate with an APC having a connecting structure designed only for a common-anode laser diode.

### SUMMARY OF THE INVENTION

An aspect of the present invention is to address at least the above problems and/or disadvantages and to provide at least the advantages described below. Accordingly, an aspect of the present invention is to provide an apparatus for controlling laser output that can use the same automatic power controller (APC) regardless of the type of laser diodes used.

According to an aspect of the present invention, there is provided an apparatus for controlling a laser output, the apparatus comprises a common-anode laser diode having a first light emitting unit and a first light receiving unit and a common-cathode laser diode having a second light emitting unit and a second light receiving unit. Further, the apparatus comprises an automatic power controller (APC) that operates in either one of two modes. In the first mode the APC controls the amount of light emitted from the first light emitting unit by comparing a first feedback voltage corresponding to an amount of light received by the first light receiving unit and a reference voltage. In the second mode, the APC controls the amount of light emitted from the second light emitting unit by comparing a second feedback voltage corresponding to an amount of light received by the second light receiving unit and a reference voltage. Still further, the apparatus comprises a switching unit which connects the APC and the common-anode laser diode and the apparatus comprises a bias direction forming unit which forms a bias direction between the switching unit and the common-cathode laser diode.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features, and advantages of certain embodiments of the present invention will be more apparent from the following description taken in conjunction with the accompanying drawings, in which:

FIG. 1 is an exemplary view of a conventional apparatus for controlling laser output of a common-anode type laser;

FIG. 2 is another exemplary conventional apparatus for controlling laser output of a common-cathode type laser;

FIG. 3 is a view of an apparatus for controlling a laser output according to an embodiment of the present invention; and

FIG. 4 is a view of another bias direction forming unit different from the one illustrated in FIG. 3.

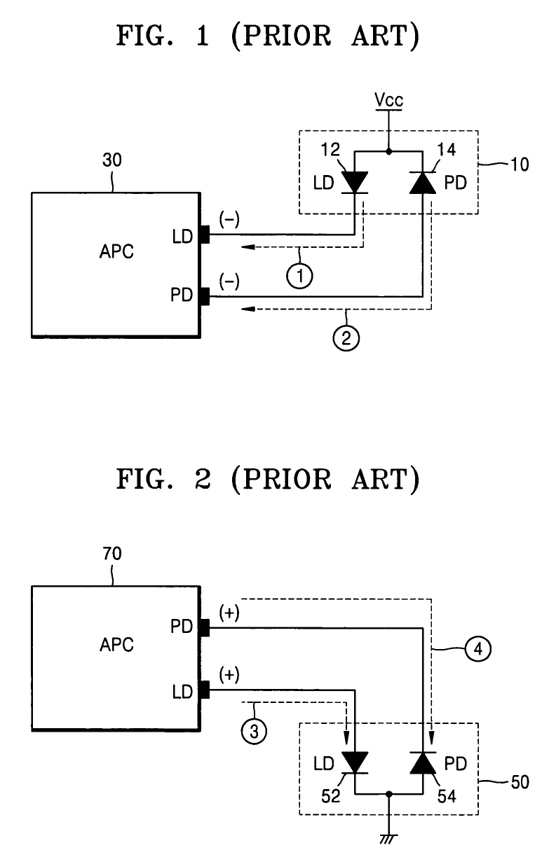

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

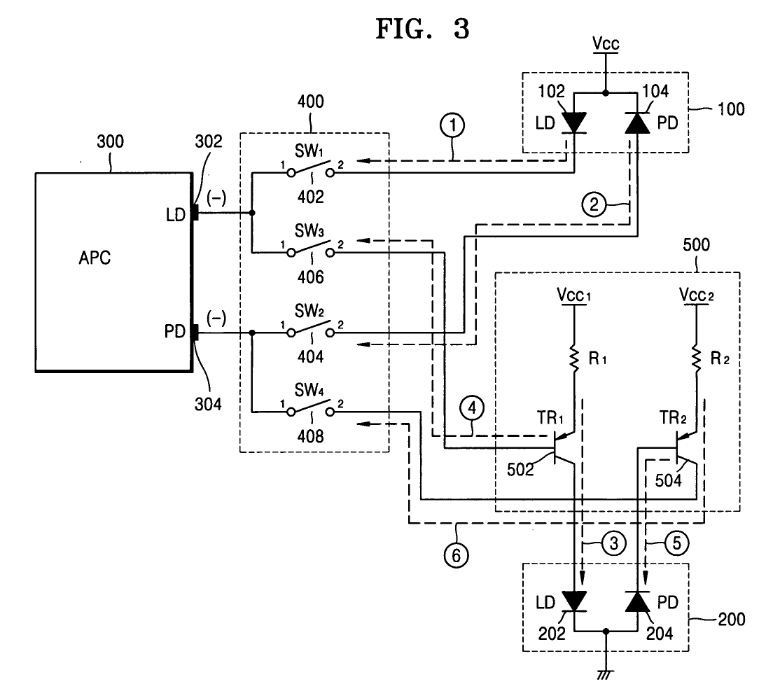

FIG. 3 is a view of an apparatus for controlling a laser output according to an embodiment of the present invention. The apparatus includes a common-anode laser diode 100, a common-cathode laser diode 200, an automatic power controller (APC) 300, a switching unit 400, and a bias direction forming unit 500.

The common-anode laser diode 100 includes a first light emitting unit 102 and a first light receiving unit 104. The first light emitting unit 102 is preferably a light emitting diode (LED) which emits light when current flows through a P-N junction of a semiconductor. An anode of the first light emitting unit 104 is connected to a voltage source Vcc. The first light receiving unit 104 is a device which converts light into electricity. An exemplary light receiving unit 104 is an avalanche photodiode (APD). A cathode of the first light receiving unit 104 is connected to the voltage source Vcc.

The common-cathode laser diode 200 includes a second LED 202 and a second light receiving unit 204. The second light emitting unit 202, like the first light emitting unit 102, is an LED which emits light when current flows through a P-N junction of a semiconductor. A cathode of the second light emitting unit 204 is connected to ground GND. The second light receiving unit 204, like the first light receiving unit 104, is a device which converts light into electricity. An anode of the second light receiving unit 204 is connected to the ground GND.

The APC 300 operates in either one of two modes. In the first mode, the APC 300 controls the amount of light emitted from the first light emitting unit 102 by comparing a first feedback voltage corresponding to the amount of light received by the first light receiving unit 104 and a first reference voltage. In the second mode, the APC 300 controls the amount of light emission of the second light emitting unit 202 by comparing a second feedback voltage corresponding to the amount of light received by the second light receiving unit 204 and a second reference voltage. Of course, the first reference voltage and second reference voltage can the substantially the same or different. The APC 300 includes a light emitting unit port 302 and a light receiving unit port 304.

The switching unit 400 connects the APC 300 and the common-anode laser diode 100. The switching unit 400 includes a first switch SW₁ 402, a second switch SW₂ 404, a third switch SW₃ 406, and a fourth switch SW₄ 408.

One end of the first switch SW₁ 402 is connected to the light emitting unit port 302, and the other end of the first switch SW₁ 402 is connected to the cathode of the first light emitting unit 102. The anode of the first light emitting unit 102 of the common-anode laser diode 100 is connected to voltage source Vcc, and the cathode of the first light emitting unit 102 is connected to the light emitting unit port 302 of the APC 300 through the first switch SW₁ 402. Thus, a direction bias (1) is formed.

One end of the second switch SW₂ 404 is connected to the light receiving unit port 304, and the other end of the second switch SW₂ 404 is connected to the anode of the first light receiving unit 104. The cathode of the first light receiving unit 104 of the common-anode laser diode 100 is connected to the voltage source Vcc, and the anode of the first light receiving unit 104 is connected to the light receiving unit port 304 of the APC 300 through the second switch SW₂ 404. Thus, a reverse direction bias (2) is formed.

To use the apparatus for controlling a laser output for use, with the common-anode laser diode 100, the apparatus is configured by connecting the common-anode laser diode 100 and the APC 300 via the first and second switches SW₁ 402 and SW₂ 404. Here, third and fourth switches SW₃ 406 and SW₄ 408 are normally open.

The bias direction forming unit 500 forms a bias direction between the switching unit 400 and the common-cathode laser diode 200. The bias direction forming unit 500 includes a first transistor 502 and a second transistor 504. Preferably, the first and second transistors 502 and 504 are PNP transistors.

A collector of the first transistor 502 is connected to the anode of the second light emitting unit 202. Also, a base of the first transistor 502 is connected to one end of the third switch SW₃ 406. In addition, an emitter of the first transistor 502 is connected to a first voltage Vcc₁. The other end of the third switch SW₃ 406 is connected to the light emitting unit port 302 of the APC 300. A direction bias is formed (3) since the collector of the first transistor 502 is connected to the anode of the second light emitting unit 202, and another direction bias (4) is formed since the base of the first transistor 502 is connected to the light emitting unit port 302 of the APC 300 through the third switch SW₃ 406.

A base of the second transistor 504 is connected to the cathode of the second light receiving unit 204. Also, a collector of the second transistor 504 is connected to one end of the fourth switch SW₄ 408. In addition, an emitter of the second transistor 504 is connected to a second voltage Vcc2. The other end of the fourth switch SW₄ 408 is connected to the light receiving unit port 304 of the APC 300. A reverse direction bias (5) is formed as the base of the second transistor 504 is connected to the cathode of the second light receiving unit 204, and another reverse direction bias (6) is formed as the collector of the second transistor 504 is connected to the light receiving unit port 304 through the fourth switch SW₄ 408.

If a user desires to compose an apparatus for controlling a laser output using the common-cathode laser diode 200, the apparatus can be configured by connecting the common-cathode laser diode 200 and the APC 300 via the third and fourth switches SW₃ 406 and SW₄ 408 and the bias direction forming unit 500. Here, the first and second switches SW₁ 402 and SW₂ 404 are normally open.

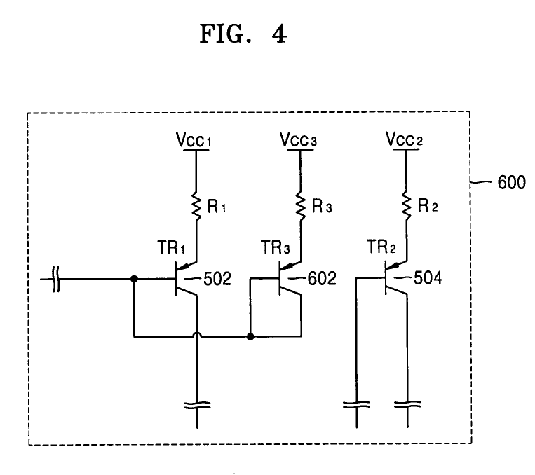

FIG. 4 is a view of another bias direction forming unit 600 according to an embodiment of the present invention. The bias direction forming unit 600 includes a third transistor 602 in addition to a first transistor 502 and a second transistor 504. Preferably, the third transistor 602 is also a PNP transistor.

As described with reference to FIG. 3, a collector of the first transistor 502 is connected to the anode of the second light emitting unit 202. In addition, a base of the first transistor 502 is connected to one end of the third switch SW₃ 406. Furthermore, an emitter of the first transistor 502 connected to a first voltage Vcc₁. Preferably, the first transistor 502 is connected to the first voltage Vcc₁ via resistor R₁. Meanwhile, the other end of the third switch SW₃ 406 is connected to the light emitting unit port 302 of the APC 300.

Also, as described with reference to FIG. 3, a base of the second transistor 504 is connected to the cathode of the second light receiving unit 204. In addition, a collector of the second transistor 504 is connected to one end of the fourth switch SW₄ 408. Furthermore, an emitter of the second transistor 504 is connected to a second voltage Vcc₂. Preferably, the second transistor 504 is connected to the second voltage Vcc₂ via resistor R₂. Meanwhile, the other end of the fourth switch SW₄ 408 is connected to the light receiving unit port 304 of the APC 300.

A base and a collector of the third transistor 602 are connected to each other, and are connected to the base of the first transistor 502. Furthermore, an emitter of the third transistor 602 is connected to a third voltage Vcc₃. Preferably, the third transistor 602 is connected to the second voltage Vcc₃ via resistor R₃. Because the bias direction forming unit includes the third transistor 602, the bias direction created by the bias direction forming unit is reliable than the bias direction created by the bias direction forming unit 500 illustrated in FIG. 3. Of course, the voltage source Vcc, first voltage Vcc₁, second voltage Vcc₂ and third voltage Vcc₃ can each be substantially similar or different from each other. Moreover, resistor R₁, resistor R₂ and resistor R₃ can each be substantially similar or different from each other.

As described above, the apparatus for controlling a laser output in a laser printer which can use both a common-anode laser diode and a common-cathode laser diode is beneficial in that it simplifies the internal circuit structure of the semiconductor laser.

In addition, the above apparatus for controlling the laser output in a laser printer is beneficial in that it enables a dual beam laser configuration while allowing a common-cathode laser diode to operate with an APC having a connecting structure designed only for a common-anode laser diode.

While the invention has been shown and described with reference to certain embodiments thereof, it will be understood by those skilled in the art that various changes in form and details may be made therein without departing from the spirit and scope of the invention as defined by the appended claims.

What is claimed is:

1. An apparatus for controlling a laser output, comprising:
a common-anode laser diode comprising a first light emitting unit and a first light receiving unit;
a common-cathode laser diode comprising a second light emitting unit and a second light receiving unit;
an automatic power controller (APC) for controlling the amount of light emitted from the first light emitting unit in a first mode and controlling the amount of light emitted from the second light emitting unit in a second mode, in the first mode the amount of light emitted from the first light emitting unit is controlled in accordance with a comparison of a first reference voltage with a first feedback voltage corresponding to the amount of light received by the first light receiving unit, in the second mode the amount of light emitted from the second light emitting unit is controlled in accordance with a comparison of a second reference voltage with a second feedback voltage corresponding to the amount of light received by the second light;
a switching unit for connecting the APC and the common-anode laser diode; and
a bias direction forming unit for forming a bias direction between the switching unit and the common-cathode laser diode.

2. The apparatus of claim 1, wherein the switching unit comprises a first switch, a second switch, a third switch, and a fourth switch.

3. The apparatus of claim 2, wherein in the apparatus, one end of the first switch is connected to a light emitting unit port of the APC and the other end of the first switch is connected to a cathode of the first light emitting unit, and
one end of the second switch is connected to a light receiving unit port of the APC and the other end of the second switch is connected to an anode of the first light receiving unit.

4. The apparatus of claim 3, wherein the bias forming unit comprises a first transistor and a second transistor.

5. The apparatus of claim 4, wherein in the apparatus, a collector of the first transistor and an anode of the second light emitting unit are connected to each other and to a first voltage source, and
a base of the second transistor and a cathode of the second light receiving unit are connected to each other and to a ground.

6. The apparatus of claim 5, wherein in the apparatus, one end of the third switch is connected to the light emitting unit port of the APC and the other end of the third switch is connected to a base of the first transistor, and
one end of the fourth switch is connected to the light receiving unit port of the APC and the other end of the fourth switch is connected to a collector of the second transistor.

7. The apparatus of claim 4, wherein the bias forming unit further comprises a third transistor.

8. The apparatus of claim 7, wherein in the apparatus, a collector of the first transistor and an anode of the second light emitting unit are connected to each other, and
a base of the second transistor and a cathode of the second light receiving unit are connected to each other.

9. The apparatus of claim 8, wherein in the apparatus, one end of the third switch is connected to the light emitting unit port of the APC and the other end of the third switch is connected to a base of the first transistor, and
one end of the fourth switch is connected to the light receiving unit port of the APC and the other end of the fourth switch is connected to a collector of the second transistor.

10. The apparatus of claim 9, wherein in the bias forming unit, a base and a collector of the third transistor and connected to each other, and the connected base and collector of the third transistor are connected to the base of the first transistor.

11. The apparatus of claim 1, wherein the APC being in the first mode or second mode depends on a state of the switching unit.

12. The apparatus of claim 6, wherein the APC being in the first mode or second mode depends on a state of the switching unit.

13. The apparatus of claim 12, wherein the APC is in the first mode when the first switch and second switch are closed, and the APC is in the second mode when the third switch and fourth switch are closed.

14. The apparatus of claim 10, wherein the APC being in the first mode or second mode depends on a state of the switching unit.

15. The apparatus of claim 14, wherein the APC is in the first mode when the first switch and second switch are closed, and the APC is in the second mode when the third switch and fourth switch are closed.

16. The apparatus of claim 1, wherein apparatus for controlling a laser output is comprised by a laser printing apparatus.

17. The apparatus of claim 4, wherein the first transistor and second transistor are PNP transistors.

18. The apparatus of claim 7, wherein the third transistor is a PNP transistor.

19. The apparatus of claim 6, wherein an emitter of the first transistor is connected to a second voltage source and an emitter of the second transistor is connected to a third voltage source.

20. The apparatus of claim 10, wherein an emitter of the first transistor is connected to a second voltage source, an emitter of the second transistor is connected to a third voltage source and an emitter of the third transistor is connected to a fourth voltage source.
